(19) United States
(12) Patent Application Publication
(10) Pub. No.: US 2020/0353949 A1
(43) Pub. Date: Nov. 12, 2020

(54) COST CALCULATION SYSTEM AND METHOD

(71) Applicant: Optimus Ride, Inc., Boston, MA (US)

(72) Inventors: ALBERT HUANG, Sunnyvale, CA (US); Patrick Barragan, Cambridge, MA (US); Janis Edelmann, Zurich (CH); Karthik Vijayakumar, Cambridge, MA (US); Sertac Karaman, Cambridge, MA (US)

(21) Appl. No.: 16/869,040

(22) Filed: May 7, 2020

Related U.S. Application Data
(60) Provisional application No. 62/844,531, filed on May 7, 2019.

(51) Int. Cl. B60W 60/00; G05D 1/02; G01C 21/34; G01C 21/36

(52) U.S. Cl. CPC B60W 60/001; G05D 1/0212; G01C 21/3691; G01C 21/3629; G01C 21/3453

(57) ABSTRACT

A method, computer program product, and computing system for determining a primary trajectory cost for a primary trajectory identified for an autonomous vehicle; determining at least one alternative trajectory cost for at least one alternative trajectory identified for the autonomous vehicle; comparing the at least one alternative trajectory cost to the primary trajectory cost; and if the at least one alternative trajectory cost is less than the primary trajectory cost, determining a basis for the at least one alternative trajectory cost being less than the primary trajectory cost.

### RELATED APPLICATION(S)

This application claims the benefit of U.S. Provisional Application No. 62/844,531, filed on 07 May 2019, the entire contents of which are incorporated herein by reference.

### TECHNICAL FIELD

This disclosure relates to cost calculation plans and, more particularly, to cost calculation plans for use in autonomous vehicles.

### BACKGROUND

As transportation moves towards autonomous (i.e., driverless) vehicles, the manufactures and designers of these autonomous vehicles must define contingencies that occur in the event of a failure of one or more of the systems within these autonomous vehicles.

As is known, autonomous vehicles contain multiple electronic control units (ECUs), wherein each of these ECUs may perform a specific function. For example, these various ECUs may calculate safe trajectories for the vehicle (e.g., for navigating the vehicle to its intended destination) and may provide control signals to the vehicle's actuators, propulsions systems and braking systems. Typically, one ECU (e.g., an Autonomy Control Unit) may be responsible for planning and calculating a trajectory for the vehicle, and may provide commands to other ECUs that may cause the vehicle to move (e.g., by controlling steering, braking, and powertrain ECUs).

As would be expected, such autonomous vehicles need to make navigation decisions that consider their surroundings/environment. Unfortunately, these navigation decisions may sometimes appear confusing for the occupant(s) of these autonomous vehicles. For example, it is foreseeable that an autonomous vehicle may realize that an accident occurred a few miles away on a highway on which the autonomous vehicle is travelling. Unfortunately, the autonomous vehicle may appear to be confusingly exiting the highway to navigate on back roads, while the autonomous vehicle is logically exiting the highway to avoid the congestion caused by the accident.

### SUMMARY OF DISCLOSURE

In one implementation, a computer-implemented method is executed on a computing device and includes: determining a primary trajectory cost for a primary trajectory identified for an autonomous vehicle; determining at least one alternative trajectory cost for at least one alternative trajectory identified for the autonomous vehicle; comparing the at least one alternative trajectory cost to the primary trajectory cost; and if the at least one alternative trajectory cost is less than the primary trajectory cost, determining a basis for the at least one alternative trajectory cost being less than the primary trajectory cost.

One or more of the following features may be included. If the at least one alternative trajectory cost is less than the primary trajectory cost, the autonomous vehicle may be navigated via the at least one alternative trajectory. An explanation for navigating the autonomous vehicle via the at least one alternative trajectory may be provided to an occupant of the autonomous vehicle. When providing an explanation for navigating the autonomous vehicle via the at least one alternative trajectory to an occupant of the autonomous vehicle, a visual explanation for navigating the autonomous vehicle via the at least one alternative trajectory may be provided to the occupant of the autonomous vehicle. When providing an explanation for navigating the autonomous vehicle via the at least one alternative trajectory to an occupant of the autonomous vehicle, an audible explanation for navigating the autonomous vehicle via the at least one alternative trajectory may be provided to the occupant of the autonomous vehicle. The primary trajectory cost and the at least one alternative trajectory cost may consider one or more real world conditions. When determining a basis for the at least one alternative trajectory cost being less than the primary trajectory cost, a proximate cause condition, selected from the one or more real world conditions, may be identified as the basis for the for the at least one alternative trajectory cost being less than the primary trajectory cost. When providing an explanation for navigating the autonomous vehicle via the at least one alternative trajectory to an occupant of the autonomous vehicle, the proximate cause condition may be explained as the basis for navigating the autonomous vehicle via the at least one alternative trajectory to an occupant of the autonomous vehicle.

In another implementation, a computer program product resides on a computer readable medium and has a plurality of instructions stored on it. When executed by a processor, the instructions cause the processor to perform operations including: determining a primary trajectory cost for a primary trajectory identified for an autonomous vehicle; determining at least one alternative trajectory cost for at least one alternative trajectory identified for the autonomous vehicle; comparing the at least one alternative trajectory cost to the primary trajectory cost; and if the at least one alternative trajectory cost is less than the primary trajectory cost, determining a basis for the at least one alternative trajectory cost being less than the primary trajectory cost.

One or more of the following features may be included. If the at least one alternative trajectory cost is less than the primary trajectory cost, the autonomous vehicle may be navigated via the at least one alternative trajectory. An explanation for navigating the autonomous vehicle via the at least one alternative trajectory may be provided to an occupant of the autonomous vehicle. When providing an explanation for navigating the autonomous vehicle via the at least one alternative trajectory to an occupant of the autonomous vehicle, a visual explanation for navigating the autonomous vehicle via the at least one alternative trajectory may be provided to the occupant of the autonomous vehicle. When providing an explanation for navigating the autonomous vehicle via the at least one alternative trajectory to an occupant of the autonomous vehicle, an audible explanation for navigating the autonomous vehicle via the at least one alternative trajectory may be provided to the occupant of the autonomous vehicle. The primary trajectory cost and the at least one alternative trajectory cost may consider one or more real world conditions. When determining a basis for the at least one alternative trajectory cost being less than the primary trajectory cost, a proximate cause condition, selected from the one or more real world conditions, may be identified as the basis for the for the at least one alternative trajectory cost being less than the primary trajectory cost. When providing an explanation for navigating the autonomous vehicle via the at least one alternative trajectory to an occupant of the autonomous vehicle, the proximate cause condition may be explained as the basis for navigating the autonomous vehicle via the at least one alternative trajectory to an occupant of the autonomous vehicle.

In another implementation, a computing system includes a processor and memory is configured to perform operations including: determining a primary trajectory cost for a primary trajectory identified for an autonomous vehicle; determining at least one alternative trajectory cost for at least one alternative trajectory identified for the autonomous vehicle; comparing the at least one alternative trajectory cost to the primary trajectory cost; and if the at least one alternative trajectory cost is less than the primary trajectory cost, determining a basis for the at least one alternative trajectory cost being less than the primary trajectory cost.

One or more of the following features may be included. If the at least one alternative trajectory cost is less than the primary trajectory cost, the autonomous vehicle may be navigated via the at least one alternative trajectory. An explanation for navigating the autonomous vehicle via the at least one alternative trajectory may be provided to an occupant of the autonomous vehicle. When providing an explanation for navigating the autonomous vehicle via the at least one alternative trajectory to an occupant of the autonomous vehicle, a visual explanation for navigating the autonomous vehicle via the at least one alternative trajectory may be provided to the occupant of the autonomous vehicle. When providing an explanation for navigating the autonomous vehicle via the at least one alternative trajectory to an occupant of the autonomous vehicle, an audible explanation for navigating the autonomous vehicle via the at least one alternative trajectory may be provided to the occupant of the autonomous vehicle. The primary trajectory cost and the at least one alternative trajectory cost may consider one or more real world conditions. When determining a basis for the at least one alternative trajectory cost being less than the primary trajectory cost, a proximate cause condition, selected from the one or more real world conditions, may be identified as the basis for the for the at least one alternative trajectory cost being less than the primary trajectory cost. When providing an explanation for navigating the autonomous vehicle via the at least one alternative trajectory to an occupant of the autonomous vehicle, the proximate cause condition may be explained as the basis for navigating the autonomous vehicle via the at least one alternative trajectory to an occupant of the autonomous vehicle.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous vehicle according to an embodiment of the present disclosure;

FIG. 2A is a diagrammatic view of one embodiment of the various systems included within the autonomous vehicle of FIG. 1 according to an embodiment of the present disclosure;

FIG. 2B is a diagrammatic view of another embodiment of the various systems included within the autonomous vehicle of FIG. 1 according to an embodiment of the present disclosure;

FIG. 3 is a diagrammatic view of another embodiment of the various systems included within the autonomous vehicle of FIG. 1 according to an embodiment of the present disclosure;

FIG. 4 is a flowchart of a cost calculation process executed on one or more systems of the autonomous vehicle of FIG. 1 according to an embodiment of the present disclosure; and

FIG. 5 is a diagrammatic view of trajectories calculated by the cost calculation process of FIG. 4 according to an embodiment of the present disclosure.

Like reference symbols in the various drawings indicate like elements.

### DETAILED DESCRIPTION OF THE PREFERRED EMBODIMENTS

### Autonomous Vehicle Overview

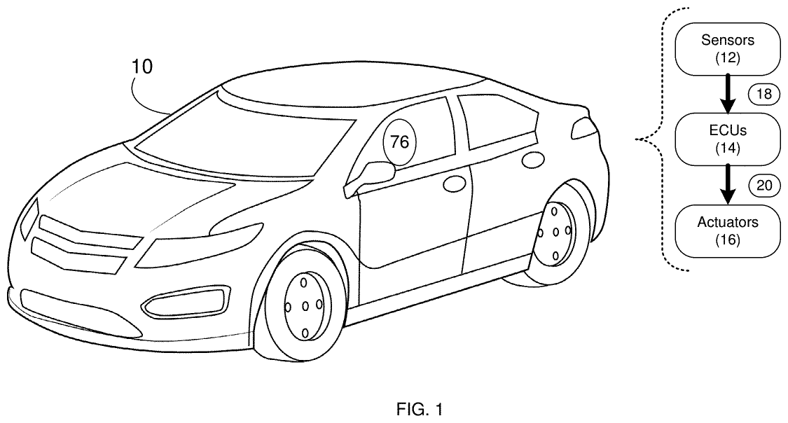

Referring to FIG. 1, there is shown autonomous vehicle 10. As is known in the art, an autonomous vehicle (e.g. autonomous vehicle 10) is a vehicle that is capable of sensing its environment and moving with little or no human input. Autonomous vehicles (e.g. autonomous vehicle 10) may combine a variety of sensor systems to perceive their surroundings, examples of which may include but are not limited to radar, computer vision, LIDAR, GPS, odometry, temperature and inertia, wherein such sensor systems may be configured to interpret lanes and markings on a roadway, street signs, stoplights, pedestrians, other vehicles, roadside objects, hazards, etc.

Autonomous vehicle 10 may include a plurality of sensors (e.g. sensors 12), a plurality of electronic control units (e.g. ECUs 14) and a plurality of actuators (e.g. actuators 16). Accordingly, sensors 12 within autonomous vehicle 10 may monitor the environment in which autonomous vehicle 10 is operating, wherein sensors 12 may provide sensor data 18 to ECUs 14. ECUs 14 may process sensor data 18 to determine the manner in which autonomous vehicle 10 should move. ECUs 14 may then provide control data 20 to actuators 16 so that autonomous vehicle 10 may move in the manner decided by ECUs 14. For example, a machine vision sensor included within sensors 12 may “read” a speed limit sign stating that the speed limit on the road on which autonomous vehicle 10 is traveling is now 35 miles an hour. This machine vision sensor included within sensors 12 may provide sensor data 18 to ECUs 14 indicating that the speed on the road on which autonomous vehicle 10 is traveling is now 35 mph. Upon receiving sensor data 18, ECUs 14 may process sensor data 18 and may determine that autonomous vehicle 10 (which is currently traveling at 45 mph) is traveling too fast and needs to slow down. Accordingly, ECUs 14 may provide control data 20 to actuators 16, wherein control data 20 may e.g. apply the brakes of autonomous vehicle 10 or eliminate any actuation signal currently being applied to the accelerator (thus allowing autonomous vehicle 10 to coast until the speed of autonomous vehicle 10 is reduced to 35 mph).

### System Redundancy

As would be imagined, since autonomous vehicle 10 is being controlled by the various electronic systems included therein (e.g. sensors 12, ECUs 14 and actuators 16), the potential failure of one or more of these systems should be considered when designing autonomous vehicle 10 and appropriate contingency plans may be employed.

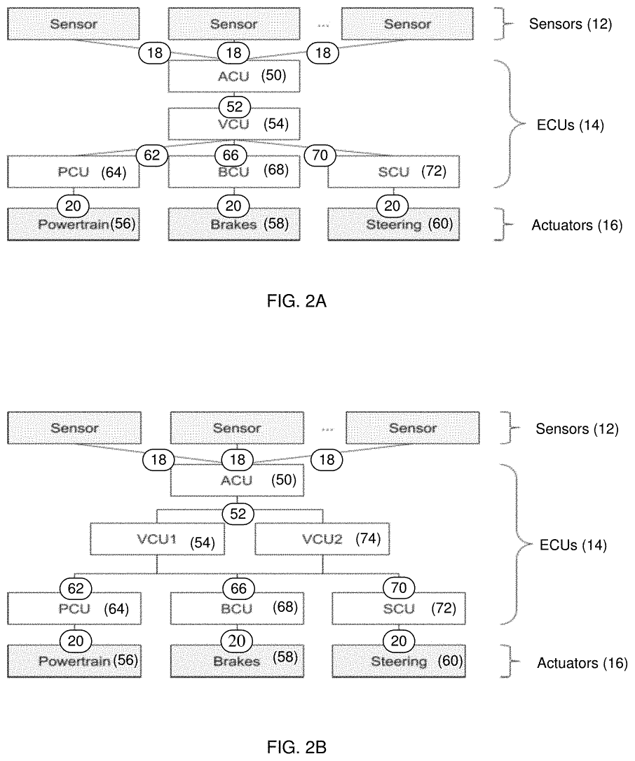

For example and referring also to FIG. 2A, the various ECUs (e.g., ECUs 14) that are included within autonomous vehicle 10 may be compartmentalized so that the responsibilities of the various ECUs (e.g., ECUs 14) may be logically grouped. For example, ECUs 14 may include autonomy control unit 50 that may receive sensor data 18 from sensors 12.

Autonomy control unit 50 may be configured to perform various functions. For example, autonomy control unit 50 may receive and process exteroceptive sensor data (e.g., sensor data 18), may estimate the position of autonomous vehicle 10 within its operating environment, may calculate a representation of the surroundings of autonomous vehicle 10, may compute safe trajectories for autonomous vehicle 10, and may command the other ECUs (in particular, a vehicle control unit) to cause autonomous vehicle 10 to execute a desired maneuver. Autonomy control unit 50 may include substantial compute power, persistent storage, and memory.

Accordingly, autonomy control unit 50 may process sensor data 18 to determine the manner in which autonomous vehicle 10 should be operating. Autonomy control unit 50 may then provide vehicle control data 52 to vehicle control unit 54, wherein vehicle control unit 54 may then process vehicle control data 52 to determine the manner in which the individual control systems (e.g. powertrain system 56, braking system 58 and steering system 60) should respond in order to achieve the trajectory defined by autonomous control unit 50 within vehicle control data 52.

Vehicle control unit 54 may be configured to control other ECUs included within autonomous vehicle 10. For example, vehicle control unit 54 may control the steering, powertrain, and brake controller units. For example, vehicle control unit 54 may provide: powertrain control signal 62 to powertrain control unit 64; braking control signal 66 to braking control unit 68; and steering control signal 70 to steering control unit 72.

Powertrain control unit 64 may process powertrain control signal 62 so that the appropriate control data (commonly represented by control data 20) may be provided to powertrain system 56. Additionally, braking control unit 68 may process braking control signal 66 so that the appropriate control data (commonly represented by control data 20) may be provided to braking system 58. Further, steering control unit 72 may process steering control signal 70 so that the appropriate control data (commonly represented by control data 20) may be provided to steering system 60.

Powertrain control unit 64 may be configured to control the transmission (not shown) and engine / traction motor (not shown) within autonomous vehicle 10; while brake control unit 68 may be configured to control the mechanical/regenerative braking system (not shown) within autonomous vehicle 10; and steering control unit 72 may be configured to control the steering column/steering rack (not shown) within autonomous vehicle 10.

Autonomy control unit 50 may be a highly complex computing system that may provide extensive processing capabilities (e.g., a workstation-class computing system with multi-core processors, discrete co-processing units, gigabytes of memory, and persistent storage). In contrast, vehicle control unit 54 may be a much simpler device that may provide processing power equivalent to the other ECUs included within autonomous vehicle 10 (e.g., a computing system having a modest microprocessor (with a CPU frequency of less than 200 megahertz), less than 1 megabyte of system memory, and no persistent storage). Due to these simpler designs, vehicle control unit 54 may have greater reliability and durability than autonomy control unit 50.

To further enhance redundancy and reliability, one or more of the ECUs (ECUs 14) included within autonomous vehicle 10 may be configured in a redundant fashion. For example and referring also to FIG. 2B, there is shown one implementation of ECUs 14 wherein a plurality of vehicle control units are utilized. For example, this particular implementation is shown to include two vehicle control units, namely a first vehicle control unit (e.g., vehicle control unit 54) and a second vehicle control unit (e.g., vehicle control unit 74).

In this particular configuration, the two vehicle control units (e.g. vehicle control units 54, 74) may be configured in various ways. For example, the two vehicle control units (e.g. vehicle control units 54, 74) may be configured in an active—passive configuration, wherein e.g. vehicle control unit 54 performs the active role of processing vehicle control data 52 while vehicle control unit 74 assumes a passive role and is essentially in standby mode. In the event of a failure of vehicle control unit 54, vehicle control unit 74 may transition from a passive role to an active role and assume the role of processing vehicle control data 52. Alternatively, the two vehicle control units (e.g. vehicle control units 54, 74) may be configured in an active—active configuration, wherein e.g. both vehicle control unit 52 and vehicle control unit 74 perform the active role of processing vehicle control data 54 (e.g. divvying up the workload), wherein in the event of a failure of either vehicle control unit 54 or vehicle control unit 74, the surviving vehicle control unit may process all of vehicle control data 52.

While FIG. 2B illustrates one example of the manner in which the various ECUs (e.g. ECUs 14) included within autonomous vehicle 10 may be configured in a redundant fashion, this is for illustrative purposes only and is not intended to be a limitation of this disclosure, as other configurations are possible and are considered to be within the scope of this disclosure. For example, autonomous control unit 50 may be configured in a redundant fashion, wherein a second autonomous control unit (not shown) is included within autonomous vehicle 10 and is configured in an active—passive or active—active fashion. Further, it is foreseeable that one or more of the sensors (e.g., sensors 12) and/or one or more of the actuators (e.g. actuators 16) may be configured in a redundant fashion. Accordingly, it is understood that the level of redundancy achievable with respect to autonomous vehicle 10 may only be limited by the design criteria and budget constraints of autonomous vehicle 10.

### Autonomy Computational Subsystems

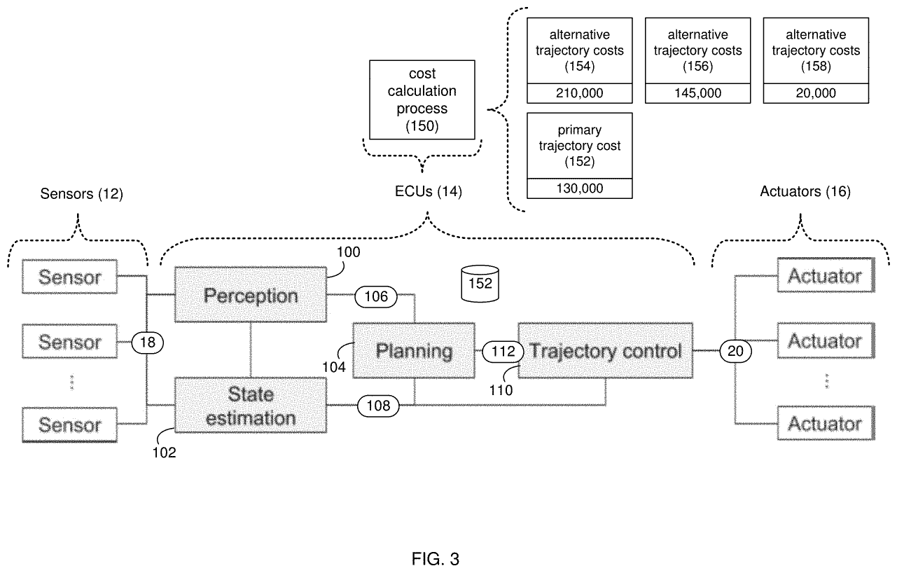

Referring also to FIG. 3, the various ECUs of autonomous vehicle 10 may be grouped/arranged/configured to effectuate various functionalities.

For example, one or more of ECUs 14 may be configured to effectuate/form perception subsystem 100. wherein perception subsystem 100 may be configured to process data from onboard sensors (e.g., sensor data 18) to calculate concise representations of objects of interest near autonomous vehicle 10 (examples of which may include but are not limited to other vehicles, pedestrians, traffic signals, traffic signs, road markers, hazards, etc.) and to identify environmental features that may assist in determining the location of autonomous vehicle 10. Further, one or more of ECUs 14 may be configured to effectuate/form state estimation subsystem 102, wherein state estimation subsystem 102 may be configured to process data from onboard sensors (e.g., sensor data 18) to estimate the position, orientation, and velocity of autonomous vehicle 10 within its operating environment. Additionally, one or more of ECUs 14 may be configured to effectuate/form planning subsystem 104, wherein planning subsystem 104 may be configured to calculate a desired vehicle trajectory (using perception output 106 and state estimation output 108). Further still, one or more of ECUs 14 may be configured to effectuate/form trajectory control subsystem 110, wherein trajectory control subsystem 110 uses planning output 112 and state estimation output 108 (in conjunction with feedback and/or feedforward control techniques) to calculate actuator commands (e.g., control data 20) that may cause autonomous vehicle 10 to execute its intended trajectory within it operating environment.

For redundancy purposes, the above-described subsystems may be distributed across various devices (e.g., autonomy control unit 50 and vehicle control units 54, 74). Additionally/alternatively and due to the increased computational requirements, perception subsystem 100 and planning subsystem 104 may be located almost entirely within autonomy control unit 50, which (as discussed above) has much more computational horsepower than vehicle control units 54, 74. Conversely and due to their lower computational requirements, state estimation subsystem 102 and trajectory control subsystem 110 may be: located entirely on vehicle control units 54, 74 if vehicle control units 54, 74 have the requisite computational capacity; and/or located partially on vehicle control units 54, 74 and partially on autonomy control unit 50. However, the location of state estimation subsystem 102 and trajectory control subsystem 110 may be of critical importance in the design of any contingency planning architecture, as the location of these subsystems may determine how contingency plans are calculated, transmitted, and/or executed.

### Trajectory Calculation

During typical operation of autonomous vehicle 10, the autonomy subsystems described above repeatedly perform the following functionalities of:
Measuring the surrounding environment using on-board sensors (e.g. using sensors 12);
Estimating the positions, velocities, and future trajectories of surrounding vehicles, pedestrians, cyclists, other objects near autonomous vehicle 10, and environmental features useful for location determination (e.g., using perception subsystem 100);
Estimating the position, orientation, and velocity of autonomous vehicle 10 within the operating environment (e.g., using state estimation subsystem 102);
Planning a nominal trajectory for autonomous vehicle 10 to follow that brings autonomous vehicle 10 closer to the intended destination of autonomous vehicle 10 (e.g., using planning subsystem 104); and
Generating commands (e.g., control data 20) to cause autonomous vehicle 10 to execute the intended trajectory (e.g., using trajectory control subsystem 110)

During each iteration, planning subsystem 104 may calculate a trajectory that may span travel of many meters (in distance) and many seconds (in time). However, each iteration of the above-described loop may be calculated much more frequently (e.g., every ten milliseconds). Accordingly, autonomous vehicle 10 may be expected to execute only a small portion of each planned trajectory before a new trajectory is calculated (which may differ from the previously-calculated trajectories due to e.g., sensed environmental changes).

### Trajectory Execution

The above-described trajectory may be represented as a parametric curve that describes the desired future path of autonomous vehicle 10. There may be two major classes of techniques for controlling autonomous vehicle 10 while executing the above-described trajectory: a) feedforward control and b) feedback control.

Under nominal conditions, a trajectory is executed using feedback control, wherein feedback trajectory control algorithms may use e.g., a kinodynamic model of autonomous vehicle 10, per-vehicle configuration parameters, and a continuously-calculated estimate of the position, orientation, and velocity of autonomous vehicle 10 to calculate the commands that are provided to the various ECUs included within autonomous vehicle 10.

Feedforward trajectory control algorithms may use a kinodynamic model of autonomous vehicle 10, per-vehicle configuration parameters, and a single estimate of the initial position, orientation, and velocity of autonomous vehicle 10 to calculate a sequence of commands that are provided to the various ECUs included within autonomous vehicle 10, wherein the sequence of commands are executed without using any real-time sensor data (e.g. from sensors 12) or other information.

To execute the above-described trajectories, autonomy control unit 50 may communicate with (and may provide commands to) the various ECUs, using vehicle control unit 54/74 as an intermediary. At each iteration of the above-described trajectory execution loop, autonomy control unit 50 may calculate steering, powertrain, and brake commands that are provided to their respective ECUs (e.g., powertrain control unit 64, braking control unit 68, and steering control unit 72; respectively), and may transmit these commands to vehicle control unit 54/74. Vehicle control unit 54/74 may then validate these commands and may relay them to the various ECUs (e.g., powertrain control unit 64, braking control unit 68, and steering control unit 72; respectively).

### Cost Calculation Process

As discussed above and during typical operation of autonomous vehicle 10, the autonomy subsystems described above may repeatedly perform the following functionalities of: measuring the surrounding environment using on-board sensors (e.g. using sensors 12); estimating the positions, velocities, and future trajectories of surrounding vehicles, pedestrians, cyclists, other objects near autonomous vehicle 10, and environmental features useful for location determination (e.g., using perception subsystem 100); estimating the position, orientation, and velocity of autonomous vehicle 10 within the operating environment (e.g., using state estimation subsystem 102); planning a nominal trajectory for autonomous vehicle 10 to follow that brings autonomous vehicle 10 closer to the intended destination of autonomous vehicle 10 (e.g., using planning subsystem 104); and generating commands (e.g., control data 20) to cause autonomous vehicle 10 to execute the intended trajectory (e.g., using trajectory control subsystem 110).

In order to calculate such trajectories, one or more of ECUs 14 may execute cost calculation process 150. Cost calculation process 150 may be executed on a single ECU or may be executed collaboratively across multiple ECUs. For example, cost calculation process 150 may be executed solely by autonomy control unit 50, vehicle control unit 54 or vehicle control unit 74. Alternatively, cost calculation process 150 may be executed collaboratively across the combination of autonomy control unit 50, vehicle control unit 54 and vehicle control unit 74. Accordingly and in the latter configuration, in the event of a failure of one of autonomy control unit 50, vehicle control unit 54 or vehicle control unit 74, the surviving control unit(s) may continue to execute cost calculation process 150.

The instruction sets and subroutines of cost calculation process 150, which may be stored on storage device 152 coupled to ECUs 14, may be executed by one or more processors (not shown) and one or more memory architectures (not shown) included within ECUs 14. Examples of storage device 152 may include but are not limited to: a hard disk drive; a RAID device; a random access memory (RAM); a read-only memory (ROM); and all forms of flash memory storage devices.

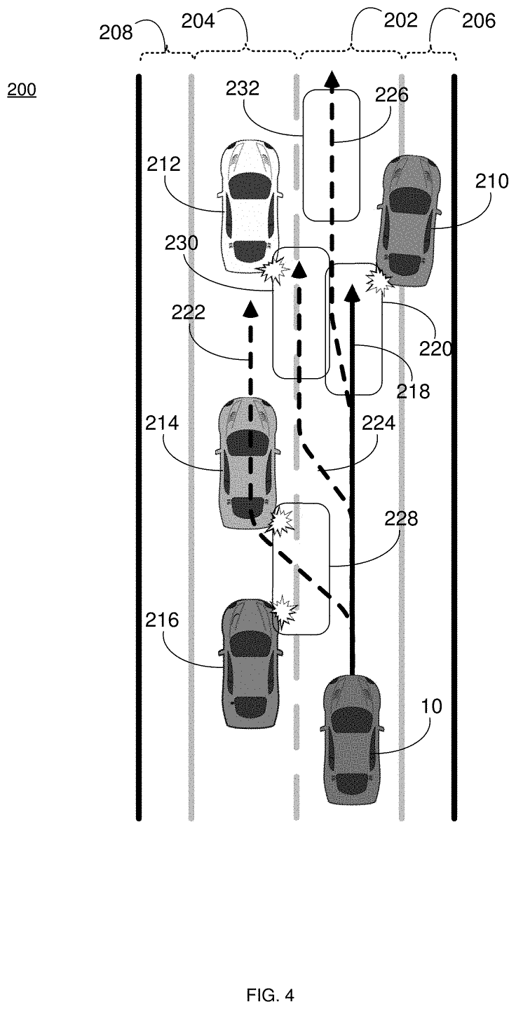

Referring also to FIG. 4, assume that roadway 200 is a single-direction, two-lane roadway that includes right lane 202, left lane 204 right shoulder 206 and left shoulder 208. Further assume that autonomous vehicle 10 is traveling in right lane 202 of roadway 200. Additionally, assume that a disabled vehicle (e.g. disabled vehicle 210) is partially obstructing right lane 202 (and partially in right shoulder 206). As discussed above, autonomous vehicle 10 will continuously scan its surroundings and environment (in the manner described above) to determine the manner in which autonomous vehicle 10 should operate. As further discussed above, the various systems/subsystems of autonomous vehicle 10 may calculate a trajectory that may span travel of many meters (in distance) and many seconds (in time). Accordingly and at some point in time, autonomous vehicle 10 may detect that disabled vehicle 210 is partially obstructing right lane 202.

When calculating the various trajectories available to autonomous vehicle 10 and determining which of these trajectories autonomous vehicle 10 should utilize, autonomous vehicle 10 (and the various systems/subsystems included therein) may assign a “cost” to each of these trajectories. As used in this example, the cost assigned to a trajectory may be any indicator that enables autonomous vehicle 10 (and the systems/subsystems included therein) to compare these trajectories and select the trajectory that is most suited for the navigation task at hand. For example, a lower cost trajectory may be selected instead of a higher cost trajectory, wherein the lower cost trajectory may be safer/quicker/more efficient trajectory and the higher cost trajectory may be riskier/slower/less efficient trajectory. While the units of a trajectory cost may vary, it is the magnitude of the cost that is indicative of the risk. And while the following discussion concerns a numerically higher number being indicative of high cost and a numerically lower number being indicative of low cost, this is for illustrative purposes only and is not intended to be a limitation of this disclosure, as other configurations are possible and are considered to be within the scope of this disclosure. For example, it is foreseeable that a numerically lower number may be indicative of high cost and a numerically higher number being indicative of low cost.

Assume for this example that other vehicles are also traveling on roadway 200 with autonomous vehicle 10. For example, vehicles 212, 214, 216 may be traveling in left lane 204 of roadway 200.

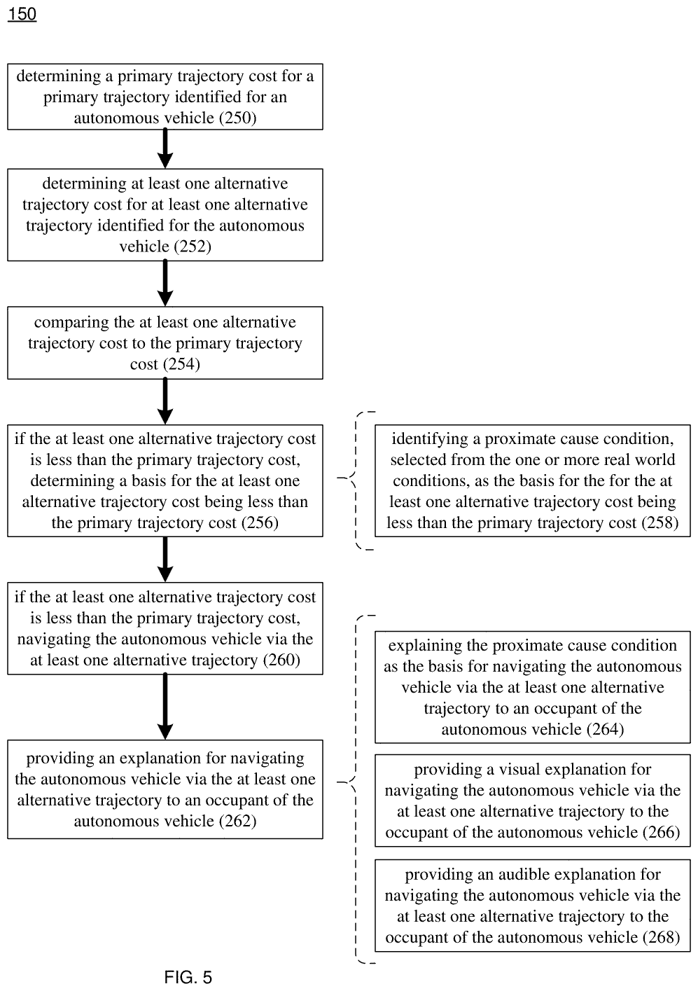

Referring also to FIG. 5, cost calculation process 150 may determine 250 a primary trajectory cost for a primary trajectory identified for an autonomous vehicle (e.g., autonomous vehicle 10). As discussed above and in this example, autonomous vehicle 10 may be traveling in right lane 202 of roadway 200. Accordingly, the primary trajectory (e.g. primary trajectory 218) for autonomous vehicle 10 has autonomous vehicle 10 continuing to travel down the center of right lane 202 of roadway 200. In one implementation, primary trajectory 218 may be determined by solving a motion planning problem wherein certain real-world costs may be ignored. Unfortunately and as discussed above, disabled vehicle 210 is partially obstruction right lane 202. Accordingly and in the event that autonomous vehicle 10 continues along primary trajectory 218, autonomous vehicle 10 will be involved in an accident with disabled vehicle 210 (as illustrated with silhouette representation 220 of autonomous vehicle 10).

As discussed above, the cost assigned to a trajectory may be any indicator that enables autonomous vehicle 10 (and the systems/subsystems included therein) to compare these trajectories and select the trajectory that is most suited for the navigation task at hand. So when cost calculation process 150 determines 250 a primary trajectory cost (e.g., primary trajectory cost 152) for a primary trajectory (e.g. primary trajectory 218) identified for an autonomous vehicle (e.g., autonomous vehicle 10), cost calculation process 150 may determine 250 a primary trajectory cost (e.g., primary trajectory cost 152) for a primary trajectory (e.g. primary trajectory 218) that is considerably high, as continued travel by autonomous vehicle 10 would result in an accident. Accordingly, assume that cost calculation process 150 determines 250 a primary trajectory cost (e.g., primary trajectory cost 152) of 130,000 for primary trajectory 218.

Additionally, cost calculation process 150 may determine 252 at least one alternative trajectory cost for at least one alternative trajectory identified for the autonomous vehicle (e.g., autonomous vehicle 10). For this example, assume that three alternative trajectories (e.g., alternative trajectories 222, 224, 226) are identified by cost calculation process 150, wherein cost calculation process 150 may determine 252 an alternative trajectory cost for each. Specifically, alternative trajectory 222 would require autonomous vehicle 10 to fully change lanes (i.e., from right lane 202 to left lane 204), while alternative trajectory 224 would require autonomous vehicle 10 to straddle right lane 202 and left lane 204, and alternative trajectory 224 would require autonomous vehicle 10 to reposition autonomous vehicle 10 into the left side of right lane 202,

Cost calculation process 150 may analyze alternative trajectory 222 to understand how autonomous vehicle 10 may interact with the current (and predicted) positions of vehicles 212, 214, 216. Accordingly, cost calculation process 10 may determine that autonomous vehicle 10 will be involved in an accident with vehicles 214, 216 (as illustrated with silhouette representation 228 of autonomous vehicle 10) if autonomous vehicle 10 chooses alternative trajectory 222, Therefore, cost calculation process 150 may determine 252 an alternative trajectory cost (e.g., alternative trajectory cost 154) for alternative trajectory 222 that is considerably high, as continued travel by autonomous vehicle 10 would result in an accident with vehicles 214, 216. Accordingly, assume that cost calculation process 150 determines 252 an alternative trajectory cost (e.g., alternative trajectory cost 154) of 210,000 for alternative trajectory 222.

Further, cost calculation process 150 may analyze alternative trajectory 224 to understand how autonomous vehicle 10 may interact with the current (and predicted) positions of vehicles 212, 214, 216. Accordingly, cost calculation process 10 may determine that autonomous vehicle 10 will be involved in an accident with vehicle 212 (as illustrated with silhouette representation 230 of autonomous vehicle 10) if autonomous vehicle 10 chooses alternative trajectory 224, Therefore, cost calculation process 150 may determine 252 an alternative trajectory cost (e.g., alternative trajectory cost 156) for alternative trajectory 224 that is considerably high, as continued travel by autonomous vehicle 10 would result in an accident with vehicle 212. Accordingly, assume that cost calculation process 150 determines 252 an alternative trajectory cost (e.g., alternative trajectory cost 154) of 145,000 for alternative trajectory 224.

Additionally, cost calculation process 150 may analyze alternative trajectory 226 to understand how autonomous vehicle 10 may interact with the current (and predicted) positions of vehicles 212, 214, 216. Accordingly, cost calculation process 10 may determine that autonomous vehicle 10 will not be involved in an accident with any of vehicles 212, 214, 216 (as illustrated with silhouette representation 232 of autonomous vehicle 10) if autonomous vehicle 10 chooses alternative trajectory 226, Therefore, cost calculation process 150 may determine 252 an alternative trajectory cost (e.g., alternative trajectory cost 158) for alternative trajectory 222 that is considerably low, as continued travel by autonomous vehicle 10 would result in no accidents. Accordingly, assume that cost calculation process 150 determines 252 an alternative trajectory cost (e.g., alternative trajectory cost 156) of 20,000 for alternative trajectory 226.

Once these costs are determined 250, 252, cost calculation process 150 may compare 254 the at least one alternative trajectory cost (e.g., alternative trajectory costs 154, 156, 158) to the primary trajectory cost (e.g., primary trajectory cost 152).

If the at least one alternative trajectory cost (e.g., alternative trajectory costs 154, 156, 158) is less than the primary trajectory cost (e.g., primary trajectory cost 152), cost calculation process 150 may determine 256 a basis for the at least one alternative trajectory cost (e.g., alternative trajectory costs 154, 156, 158) being less than the primary trajectory cost (e.g., primary trajectory cost 152). In this particular example, primary trajectory cost 152 is 130,000, alternative trajectory cost 154 is 210,000, alternative trajectory cost 156 is 145,000, and alternative trajectory cost 158 is 20,000). Accordingly and upon comparing 254 the at least one alternative trajectory cost (e.g., alternative trajectory costs 154, 156, 158) to the primary trajectory cost (e.g., primary trajectory cost 152), it becomes readily apparent that alternative trajectory 226 has the lowest alternative trajectory cost (e.g. alternative trajectory cost 158 of 20,000).

When cost calculation process 150 determines 256 a basis for the at least one alternative trajectory cost (e.g., alternative trajectory costs 154, 156, 158) being less than the primary trajectory cost (e.g., primary trajectory cost 152), cost calculation process 150 may consider real-world conditions. Accordingly, the primary trajectory cost (e.g., primary trajectory cost 152) and the at least one alternative trajectory cost (e.g., alternative trajectory costs 154, 156, 158) may consider (and be influenced) by one or more real world conditions, examples of which may include but are not limited to: traffic conditions, weather conditions, day of week, time of day, time of year, maneuver(s) being performed, risk of accident, risk of injury, risk of vehicle damage, risk of property damage, impact on efficiency, impact on timeliness, impact on miles travelled, impact on vehicle wear, and impact on legality.

For example and with respect to primary trajectory 218, in the event that real-world conditions were not being considered by cost calculation process 150, continued travel along primary trajectory 218 would have a very low cost, as the fact that disabled vehicle 210 is partially obstructing right lane 202 would not be considered. Accordingly and if all real-world conditions were ignored, cost calculation process 150 may determine a primary trajectory cost (e.g., primary trajectory cost 152) for primary trajectory 218 that is artificially low (e.g., 5,000) as primary trajectory 218 would simply be a trajectory down the center of right lane 202 of roadway 200 (i.e., ignoring the inevitable accident with disabled vehicle 210).

However (and as discussed above) cost calculation process 150 does indeed take into account such real-world conditions when assigning such costs (e.g. primary trajectory cost 152 and alternative trajectory costs 154, 156, 158).

Accordingly and with respect to primary trajectory 218, cost calculation process 150 determined 250 a primary trajectory cost (e.g., primary trajectory cost 152) for primary trajectory 218 of 130,000, which may include:
5,000 (e.g., the base level cost of travelling in right lane 202);
10,000 (e.g., the cost of the surrounding traffic);
5,000 (e.g., the cost of travelling during rush hour); and
110,000 (e.g., the cost of being involved in an accident with one other vehicle).

And with respect to alternative trajectory 222, cost calculation process 150 determined 252 an alternative trajectory cost (e.g., alternative trajectory cost 154) for alternative trajectory 222 of 210,000, which may include:
10,000 (e.g., the base level cost of travelling in left lane 204);
10,000 (e.g., the cost of performing a lane change maneuver);
10,000 (e.g., the cost of the surrounding traffic);
5,000 (e.g., the cost of travelling during rush hour); and
175,000 (e.g., the cost of being involved in an accident with two other vehicles).

And with respect to alternative trajectory 224, cost calculation process 150 determined 252 an alternative trajectory cost (e.g., alternative trajectory cost 156) for alternative trajectory 224 of 145,000, which may include:
10,000 (e.g., the base level cost of travelling in left lane 204);
10,000 (e.g., the cost of performing a lane change maneuver);
10,000 (e.g., the cost of the surrounding traffic);
5,000 (e.g., the cost of travelling during rush hour); and
110,000 (e.g., the cost of being involved in an accident with two other vehicles).

And with respect to alternative trajectory 226, cost calculation process 150 determined 252 an alternative trajectory cost (e.g., alternative trajectory cost 158) for alternative trajectory 226 of 20,000, which may include:
5,000 (e.g., the base level cost of travelling in right lane 202);
10,000 (e.g., the cost of the surrounding traffic); and
5,000 (e.g., the cost of travelling during rush hour).

When determining 256 a basis for the at least one alternative trajectory cost (e.g., alternative trajectory costs 152, 154, 156) being less than the primary trajectory cost (e.g., primary trajectory cost 152), cost calculation process 150 may identify 258 a proximate cause condition (selected from the one or more real world conditions) as the basis for the at least one alternative trajectory cost (e.g., alternative trajectory costs 152, 154, 156) being less than the primary trajectory cost (e.g., primary trajectory cost 152).

As discussed above and with respect to primary trajectory 218, primary trajectory cost 152 included the following real-world conditions:
5,000 (e.g., the base level cost of travelling in right lane 202);
10,000 (e.g., the cost of the surrounding traffic);
5,000 (e.g., the cost of travelling during rush hour); and
110,000 (e.g., the cost of being involved in an accident with one other vehicle).

As discussed above and with respect to alternative trajectory 226, alternative trajectory cost 158 included the following real world conditions:
5,000 (e.g., the base level cost of travelling in right lane 202);
10,000 (e.g., the cost of the surrounding traffic); and
5,000 (e.g., the cost of travelling during rush hour).

Accordingly, cost calculation process 150 may identify 258 the accident cost (110,000) as the proximate cause condition (i.e., the basis) for alternative trajectory cost 158 (in this example) being less than primary trajectory cost 152.

If the at least one alternative trajectory cost (e.g., one of alternative trajectory costs 152, 154, 156) is less than the primary trajectory cost (e.g., primary trajectory cost 152), cost calculation process 150 may navigate 260 the autonomous vehicle (e.g., autonomous vehicle 10) via the at least one alternative trajectory (e.g., one of alternative trajectories 222, 224, 226).

Accordingly, cost calculation process 10 may select alternative trajectory 226 as the trajectory to replace primary trajectory 218, as alternative trajectory 226 has the lowest cost (20,000) as it avoids the accident with disabled vehicle 210 (while avoiding accidents with any other vehicles). Accordingly, cost calculation process 150 may navigate 260 autonomous vehicle 10 via alternative trajectory 226.

Cost calculation process 150 may provide 262 an explanation for navigating the autonomous vehicle (e.g., autonomous vehicle 10) via the at least one alternative trajectory (e.g., alternative trajectory 226) to an occupant (e.g., occupant 76) of the autonomous vehicle (e.g., autonomous vehicle 10).

When providing 262 an explanation for navigating the autonomous vehicle (e.g., autonomous vehicle 10) via the at least one alternative trajectory (e.g., alternative trajectory 226) to an occupant (e.g., occupant 76) of the autonomous vehicle (e.g., autonomous vehicle 10), cost calculation process 150 may:
explain 264 the proximate cause condition as the basis for navigating the autonomous vehicle (e.g., autonomous vehicle 10) via the at least one alternative trajectory (e.g., alternative trajectory 226) to an occupant (e.g., occupant 76) of the autonomous vehicle (e.g., autonomous vehicle 10); and/or
provide 266 a visual explanation for navigating the autonomous vehicle (e.g., autonomous vehicle 10) via the at least one alternative trajectory (e.g., alternative trajectory 226) to the occupant (e.g., occupant 76) of the autonomous vehicle (e.g., autonomous vehicle 10); and/or
provide 268 an audible explanation for navigating the autonomous vehicle (e.g., autonomous vehicle 10) via the at least one alternative trajectory (e.g., alternative trajectory 226) to the occupant (e.g., occupant 76) of the autonomous vehicle (e.g., autonomous vehicle 10).

For example, cost calculation process 150 may explain 264 that the autonomous vehicle 10 is avoiding an accident with disabled vehicle 210 (the proximate cause condition) by navigating autonomous vehicle 10 via alternative trajectory 226, wherein the explanation may be provided 266 visually (via a display screen (not shown) that is included within autonomous vehicle 10) and/or may be provide audibly (via a speaker (not shown) that is included within autonomous vehicle 10.

Accordingly, cost calculation process 150 may render a display screen that reads and/or an audio signal that verbalizes the following:

Disabled Vehicle Detected Ahead

Lane Partially Blocked

Recentering in Lane to Avoid Disabled Vehicle

This Does Not Impact Your Scheduled Arrival Time

Enjoy Your Trip

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
determining a primary trajectory cost for a primary trajectory identified for an autonomous vehicle;
determining at least one alternative trajectory cost for at least one alternative trajectory identified for the autonomous vehicle;
comparing the at least one alternative trajectory cost to the primary trajectory cost; and
if the at least one alternative trajectory cost is less than the primary trajectory cost, determining a basis for the at least one alternative trajectory cost being less than the primary trajectory cost.

2. The computer-implemented method of claim 1 further comprising:
if the at least one alternative trajectory cost is less than the primary trajectory cost, navigating the autonomous vehicle via the at least one alternative trajectory.

3. The computer-implemented method of claim 2 further comprising:
providing an explanation for navigating the autonomous vehicle via the at least one alternative trajectory to an occupant of the autonomous vehicle.

4. The computer-implemented method of claim 3 wherein providing an explanation for navigating the autonomous vehicle via the at least one alternative trajectory to an occupant of the autonomous vehicle includes:
providing a visual explanation for navigating the autonomous vehicle via the at least one alternative trajectory to the occupant of the autonomous vehicle.

5. The computer-implemented method of claim 3 wherein providing an explanation for navigating the autonomous vehicle via the at least one alternative trajectory to an occupant of the autonomous vehicle includes:
providing an audible explanation for navigating the autonomous vehicle via the at least one alternative trajectory to the occupant of the autonomous vehicle.

6. The computer-implemented method of claim 3 wherein the primary trajectory cost and the at least one alternative trajectory cost considers one or more real world conditions.

7. The computer-implemented method of claim 6 wherein determining a basis for the at least one alternative trajectory cost being less than the primary trajectory cost includes:
identifying a proximate cause condition, selected from the one or more real world conditions, as the basis for the for the at least one alternative trajectory cost being less than the primary trajectory cost.

8. The computer-implemented method of claim 7 wherein providing an explanation for navigating the autonomous vehicle via the at least one alternative trajectory to an occupant of the autonomous vehicle includes:
explaining the proximate cause condition as the basis for navigating the autonomous vehicle via the at least one alternative trajectory to an occupant of the autonomous vehicle.

9. A computer program product residing on a computer readable medium having a plurality of instructions stored thereon which, when executed by a processor, cause the processor to perform operations comprising:
determining a primary trajectory cost for a primary trajectory identified for an autonomous vehicle;
determining at least one alternative trajectory cost for at least one alternative trajectory identified for the autonomous vehicle;
comparing the at least one alternative trajectory cost to the primary trajectory cost; and
if the at least one alternative trajectory cost is less than the primary trajectory cost, determining a basis for the at least one alternative trajectory cost being less than the primary trajectory cost.

10. The computer program product of claim 9 further comprising:
if the at least one alternative trajectory cost is less than the primary trajectory cost, navigating the autonomous vehicle via the at least one alternative trajectory.

11. The computer program product of claim 10 further comprising:
providing an explanation for navigating the autonomous vehicle via the at least one alternative trajectory to an occupant of the autonomous vehicle.

12. The computer program product of claim 11 wherein providing an explanation for navigating the autonomous vehicle via the at least one alternative trajectory to an occupant of the autonomous vehicle includes:
providing a visual explanation for navigating the autonomous vehicle via the at least one alternative trajectory to the occupant of the autonomous vehicle.

13. The computer program product of claim 11 wherein providing an explanation for navigating the autonomous vehicle via the at least one alternative trajectory to an occupant of the autonomous vehicle includes:
providing an audible explanation for navigating the autonomous vehicle via the at least one alternative trajectory to the occupant of the autonomous vehicle.

14. The computer program product of claim 11 wherein the primary trajectory cost and the at least one alternative trajectory cost considers one or more real world conditions.

15. The computer program product of claim 14 wherein determining a basis for the at least one alternative trajectory cost being less than the primary trajectory cost includes:
identifying a proximate cause condition, selected from the one or more real world conditions, as the basis for the for the at least one alternative trajectory cost being less than the primary trajectory cost.

16. The computer program product of claim 15 wherein providing an explanation for navigating the autonomous vehicle via the at least one alternative trajectory to an occupant of the autonomous vehicle includes:
explaining the proximate cause condition as the basis for navigating the autonomous vehicle via the at least one alternative trajectory to an occupant of the autonomous vehicle.

17. A computing system including a processor and memory configured to perform operations comprising:
determining a primary trajectory cost for a primary trajectory identified for an autonomous vehicle;
determining at least one alternative trajectory cost for at least one alternative trajectory identified for the autonomous vehicle;
comparing the at least one alternative trajectory cost to the primary trajectory cost; and
if the at least one alternative trajectory cost is less than the primary trajectory cost, determining a basis for the at least one alternative trajectory cost being less than the primary trajectory cost.

18. The computing system of claim 17 further comprising:
if the at least one alternative trajectory cost is less than the primary trajectory cost, navigating the autonomous vehicle via the at least one alternative trajectory.

19. The computing system of claim 18 further comprising:
providing an explanation for navigating the autonomous vehicle via the at least one alternative trajectory to an occupant of the autonomous vehicle.

20. The computing system of claim 19 wherein providing an explanation for navigating the autonomous vehicle via the at least one alternative trajectory to an occupant of the autonomous vehicle includes:
providing a visual explanation for navigating the autonomous vehicle via the at least one alternative trajectory to the occupant of the autonomous vehicle.

21. The computing system of claim 19 wherein providing an explanation for navigating the autonomous vehicle via the at least one alternative trajectory to an occupant of the autonomous vehicle includes:
providing an audible explanation for navigating the autonomous vehicle via the at least one alternative trajectory to the occupant of the autonomous vehicle.

22. The computing system of claim 19 wherein the primary trajectory cost and the at least one alternative trajectory cost considers one or more real world conditions.

23. The computing system of claim 22 wherein determining a basis for the at least one alternative trajectory cost being less than the primary trajectory cost includes:
identifying a proximate cause condition, selected from the one or more real world conditions, as the basis for the for the at least one alternative trajectory cost being less than the primary trajectory cost.

24. The computing system of claim 23 wherein providing an explanation for navigating the autonomous vehicle via the at least one alternative trajectory to an occupant of the autonomous vehicle includes:
explaining the proximate cause condition as the basis for navigating the autonomous vehicle via the at least one alternative trajectory to an occupant of the autonomous vehicle.
